(19) United States
(12) Patent Application Publication
(10) Pub. No.: US 2006/0151976 A1
(43) Pub. Date: Jul. 13, 2006

(54) Airbag and airbag apparatus

(75) Inventor: Kazuhiro Abe, Tokyo (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/326,367

(22) Filed: Jan. 6, 2006

(30) Foreign Application Priority Data
Jan. 11, 2005 (JP) 2005-004093
Jun. 3, 2005 (JP) 2005-164227
Dec. 13, 2005 (JP) 2005-359173

(51) Int. Cl. B60R 21/203; B60R 21/233; B60R 21/239

(52) U.S. Cl. 280/729; 280/731; 280/742; 280/743.1

(57) ABSTRACT

An airbag includes a first and a second inner panel that partition the internal part of the airbag into a first chamber, and a second chamber surrounding the first chamber. Rear-side openings that allow the first chamber to communicate with the second chamber are provided in the second inner panel. Front-side openings are provided in the first inner panel. A sum of the opening areas of the rear-side openings is greater than a sum of the opening areas of the front-side openings. The sum of the opening areas of each of the rear-side openings and the front-side openings is greater than a sum of the opening areas of vent holes. As a result, the gas generated by a gas generator is discharged from the rear-side opening in the radial direction in a large quantity, and the airbag expands quickly in the radial direction.

### BACKGROUND OF THE INVENTION AND RELATED ART STATEMENT

The present invention relates to an airbag mounted on a high-speed mobile unit such as a motor vehicle or the like, and more particularly relates to an airbag for protecting a human body by expanding in an emergency due to a collision of the motor vehicle, or the like.

Various kinds of airbag apparatus, such as a driver-side airbag apparatus or the like, are used for protecting an occupant in an emergency, such as a collision of the motor vehicle or the like. The driver-side airbag apparatus includes an airbag formed by stitching peripheral edges of each of a front panel, namely a panel of a driver side of the airbag, and a rear panel, namely a panel of a side opposite to the driver side of the airbag. At the center of the rear panel, an inflator-attaching opening for receiving a distal side of the inflator is provided. A periphery of the inflator-attaching opening is fixed to a retainer by bolts, pins, or rivets. In the rear panel, a vent hole for absorbing an impact by discharging gas in the airbag, when the driver drives into the airbag, is provided.

An airbag is disclosed in Japanese Unexamined Patent Application Publication No. 1-311930, in which an inner panel (referred to as “inner gas bag” in the reference) is provided such that an inflator-attaching opening of a rear panel is linked with a front panel, and inner space of the airbag is thereby partitioned into two of a first chamber at a center thereof and a second chamber at a periphery thereof. In the inner gas bag, a communication opening which allows the first chamber to communicate with the second chamber is provided. When the inflator is activated, the first chamber expands first and immediately after the expansion of the first chamber, the second chamber expands.

In Japanese Unexamined Patent Application Publication No. 1-311930, because the communication opening is provided only at the rear panel side of the inner panel, there is a possibility that the airbag is pressed on a steering wheel, when the airbag is expanded.

Accordingly, it is an object of the present invention to provide an airbag that expands smoothly and immediately in a radial direction of the airbag whose internal space is thus partitioned by an inner panel into a first chamber and a second chamber.

Further objects and advantages of the invention will be apparent from the following description of the invention and the associated drawings.

### SUMMARY OF THE INVENTION

An airbag according to a first embodiment of the present invention is configured to be expanded by gas from a gas generator. The airbag includes: a front panel disposed at an occupant side; and a rear panel disposed at a side opposite to the occupant, in which each of peripheral edge portions of the front panel and the rear panel are connected together. The airbag further includes: an attaching opening for the gas generator provided in a center of the rear panel; and an inner panel disposed inside the airbag, partitioning an internal part of the airbag into a first chamber at a center thereof and a second chamber surrounding the first chamber, in which an opening for communicating the first chamber with the second chamber is provided in the airbag, and in which a sum of the opening areas of the opening is determined to be from 40 cm² to 700 cm².

The airbag has one or more vent holes formed in the rear panel, and a sum A of the opening areas of the openings is greater than a sum S of the opening area of the vent holes.

In one configuration of the airbag, the vent hole is disposed at a side above the center of the airbag when the airbag is in a state of being installed in a high-speed mobile unit, and in which a sum A₂ of the opening areas of the openings disposed at a side below the center of the airbag is greater than a sum A₁ of the opening areas of the openings disposed at a side above the center of the airbag.

In another configuration of the airbag, a front-side opening of the front panel side and a rear-side opening of the rear panel side are provided in the inner panel for serving as the opening, and a sum Ar of the opening areas of the rear-side openings is greater than a sum Af of the opening areas of the front-side opening.

A thickness of the airbag is from 20 cm to 35 cm, when the airbag is expanded.

In a further configuration of the airbag, the airbag is an airbag for use in a driver's seat connected to a steering wheel and is expanded in a manner so as to cover the driver side of the steering wheel, in which at least three openings are provided to be disposed around a center of a rotation shaft of the steering wheel in approximately even intervals in the inner panel.

In a further configuration of the airbag, the airbag is an airbag for use in the driver's seat connected to the steering wheel and is expanded in a manner so as to cover the driver side of the steering wheel, and when the steering wheel has a position to drive the high-speed vehicle straight forward, at least one opening is disposed in the inner panel within areas of approximately 45° in the left and right directions around a shaft of the steering wheel relative to a line extending downwardly from the shaft of the steering wheel.

In another embodiment of the invention, an airbag apparatus includes: an airbag which is the above-described first embodiment of the airbag; and a gas generator having a gas blowing outlet.

In an airbag and an airbag apparatus according to the present invention, an opening area of a communication opening for allowing the first chamber to communicate with the second chamber in the airbag is determined to be from 40 cm² to 700 cm². When the opening area of the opening is less than 40 cm², an amount of discharging gas per unit time from the first chamber to the second chamber becomes too small and there is a possibility that an expansion rate of the second chamber is delayed. Further, when the opening area of the opening is greater than 700 cm², a pressure of gas in the first chamber rises at a slower pace and a rate of gas blown out from the first chamber to the second chamber is decreased resulting in decreasing of a deploying rate of the airbag in a radial direction.

Because the sum of the opening areas of the openings is greater than the sum of the opening area of the vent holes, the amount of inflow gas into the second chamber becomes greater than the amount of the gas discharged from the vent hole. As a result, the entire airbag, including the second chamber, completes the expanding operation earlier.

As described above, the vent hole is disposed at a side above the center of the airbag in a state of being installed in a high-speed mobile unit. Because the sum A₂ of the opening areas of the openings disposed at a side below the center of the airbag is greater than the sum A₁ of the opening areas of the openings disposed at a side above the center of the airbag, any potential problem such that the in-flow gas into the second chamber simplistically flows toward the vent hole and is discharged from the airbag, is suppressed. As a result, the entire airbag, including the second chamber, completes the expanding operation earlier.

Thus, by designing the sum of the opening areas of the opening disposed at a side below the center of the airbag to be large, the expansion of the airbag of the side below the center thereof is promoted. As a result, the airbag can suppress a forward displacement of the occupant by catching a chest region or an abdominal region of the occupant earlier.

As described above, an opening is provided in both a front side and a rear side of an inner panel, and the gas from a gas generator is entirely supplied to the second chamber through the opening. Thereby, the second chamber is expanded earlier.

Further, because a sum of the opening areas of the rear-side openings is greater than a sum of the opening areas of the front-side openings, the gas generated by the gas generator is discharged from the rear-side opening in the radial direction, in a large amount. Thereby, the airbag is immediately expanded in the radial direction.

As a result of the expanded airbag thickness, an upper body of the occupant can be sufficiently protected.

As described above, because the openings are disposed in the inner panel in approximately every 120 degrees at a maximum in a case that the openings are three (in a case that the openings are four, every 90 degrees; in a case that the openings are five, every 72 degrees, and etc.) around the center of the rotating shaft of the steering wheel, in any angle of the steering wheel at the driving posture, at least one opening exists at a side lower than the center of the rotation shaft of the steering wheel. Therefore, in any angle of the steering wheel, the gas is supplied from the first chamber to the lower portion side of the second chamber at this time.

On the other hand, the steering wheel is usually tilted in a manner such that as the portion on the steering wheel is lower, the interval between the steering wheel and the occupant becomes narrower. Therefore, it is required that the lower portion side of the airbag that covers the lower portion side of the steering wheel is promptly expanded and developed in the airbag for use in the driver's seat.

As described above, when the steering wheel has a position to drive the high-speed vehicle straight forward, at least one opening is disposed in the inner panel within areas of approximately 45° in the left and right directions around a shaft of the steering wheel relative to a line extending downwardly from the shaft of the steering wheel. Therefore, an expansion and a development of a lower portion side of the airbag (second chamber) are accelerated.

### BRIEF DESCRIPTION OF THE DRAWINGS

FIG. 1 is a cross-sectional view illustrating an airbag and an airbag apparatus according to a first embodiment of the invention.

FIG. 2 is an exploded perspective view illustrating the airbag and the airbag apparatus of FIG. 1.

FIG. 3 is an elevation view illustrating the airbag according to a second embodiment of the invention.

FIG. 4 is a cross-sectional view taken along 4-4 line of FIG. 3.

FIG. 5 is a plan view illustrating another embodiment of the airbag.

FIG. 6 is a plan view illustrating a further embodiment of the airbag.

FIG. 7 is a plan view illustrating a further embodiment of the airbag.

### DETAILED DESCRIPTION OF THE PREFERRED EMBODIMENTS

Embodiments of the present invention will be explained below with reference to the accompanying drawings.

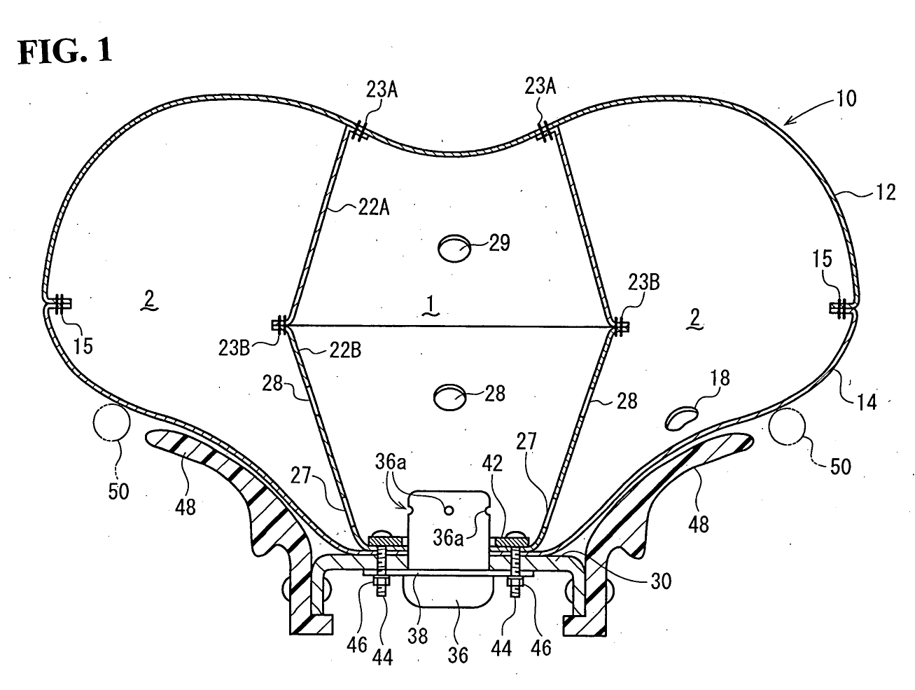

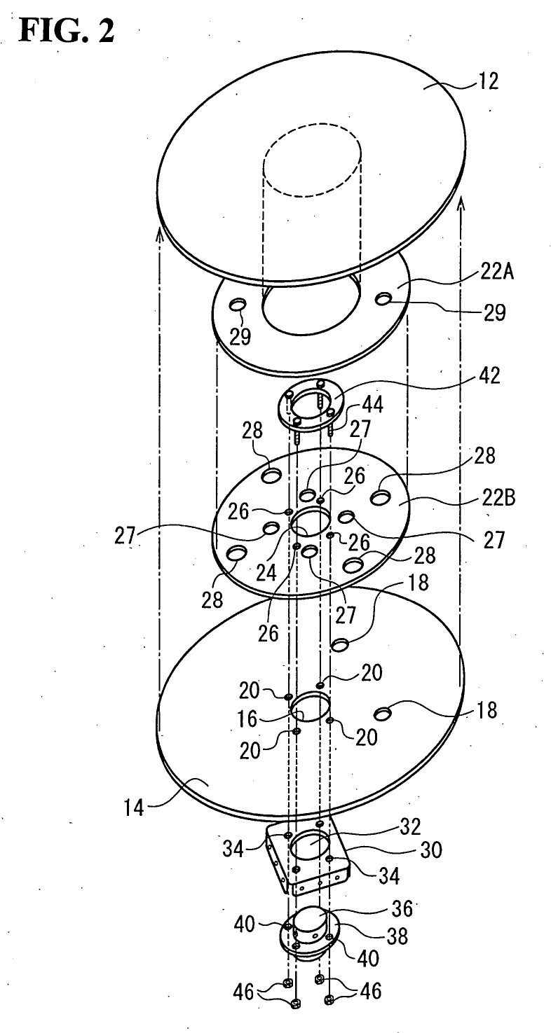

FIG. 1 is a cross-sectional view illustrating a first embodiment of a driver-side airbag of a motor vehicle and an airbag apparatus according to the present invention. FIG. 2 is an exploded perspective view of the airbag and the airbag apparatus of FIG. 1.

The airbag 10 is provided with a front panel 12, a rear panel 14, a first inner panel 22A, and a second inner panel 22B, each of which is made of a round-shaped woven cloth. The front panel 12 and the rear panel 14 have the same diameters and are formed in a bag-shaped fashion by stitching each of outer peripheral edges thereof together by a seam 15 formed of a thread or the like. The stitched part of the outer peripheral edges has a circular shape going around along the outer periphery of the front panel 12 and the rear panel 14.

An inflator (gas generator)-attaching opening 16 and one or more vent holes 18 are provided in the rear panel 14. The inflator-attaching opening 16 is disposed at a center of the rear panel 14. In addition, the inflator-attaching opening 16 is provided with bolt-penetrating holes 20 disposed around a periphery thereof.

The first inner panel 22A and the second inner panel 22B are provided inside the airbag 10. The first and the second inner panels 22A and 22B are disposed approximately concentrically with the front panel 12 and the rear panel 14 and outer peripheral edge portions of each of the first inner panel 22A and the second inner panel 22B are stitched together by a seam 23B formed with a thread or the like. An inner peripheral edge portion of the first inner panel 22A of the front panel 12 side (i.e., a peripheral edge portion of a distal side of the inner panel 22A in an expanded state of the airbag 10) is stitched with an intermediate part between a central portion and a peripheral edge portion of the front panel 12 by a seam 23A formed with a thread or the like.

At a center portion of the second inner panel 22B of the rear panel 14 side (i.e., a part that becomes a rear-end side of the second inner panel 22B in an expanded state of the airbag 10), an inflator-attaching opening 24 is disposed approximately concentrically with the inflator-attaching opening 16 of the rear panel 14. The inflator-attaching openings 16 and 24 have approximately the same diameters. Further, bolt-penetrating holes 26 are disposed around the inflator-attaching opening 24 of the inner panel 22B, overlapping with the bolt-penetrating holes 20 of the rear panel 14.

An internal part of the airbag 10 is partitioned into a first chamber 1 at the center thereof and a second chamber 2 surrounding the first chamber 1 by the first and second inner panels 22A and 22B, respectively. Further, the first chamber 1 is located inside the inner panels 22A and 22B.

A front-side opening 29 is provided in the first inner panel 22A of the front panel 12 side.

A rear-side opening 28 is disposed at a position relatively adjacent to an outer peripheral edge of the second inner panel 22B and a rear-side opening 27 is also disposed at a position closer to the inner peripheral side than the rear-side opening 28.

In this embodiment, the rear-side opening 27 is formed in extension of a gas blowing-out direction of an inflator 36, described later, which is disposed in the first chamber 1 through the inflator-attaching openings 16 and 24. In other words, the rear-side opening 27 is formed at a position facing a gas blowing outlet 36a of the inflator 36.

In this embodiment, the rear-side openings 27 and 28 are four in number, respectively, and are disposed at even distances in a circumferential direction of the airbag, as shown in FIG. 2. In addition, a phase of the rear-side openings 27 in the circumferential direction of the airbag is displaced from that of the rear-side openings 28 relative to the center of the airbag.

In this embodiment, a sum A of the respective opening areas of the rear-side openings 27 and 28, and the front-side openings 29 is greater than a sum S of the opening areas of the respective vent holes 18. The sum S of the opening areas of the opening of the vent holes 18 may be preferably from 1.5 cm² to 40 cm².

Further, the sum A of the opening areas of the opening of the front-side openings 29, and the rear-side openings 27 and 28 may be preferably from 40 cm² to 700 cm², preferably 50 cm² to 600 cm², and most preferably, from 80 cm² to 200 cm².

Furthermore, a sum Ar of the opening areas of the opening of the rear-side openings 27 and 28 is greater than a sum Af of the opening areas of the opening of the front-side openings 29 in this embodiment.

A thickness of the airbag 10 when expanded may be preferably from 20 cm to 35 cm.

An inflator-attaching opening 32 is provided in the center of a retainer 30, to which the airbag 10 is attached and bolt-penetrating holes 34 are formed around the inflator-attaching opening 32.

The inflator 36 has a substantially circular cylinder shape, and is provided with the gas blowing outlet 36a on a side circumferential surface of a distal side in a direction of a circular cylinder axis. In this embodiment, the gas blowing outlet 36a is disposed four in number at even distances in a circumferential direction of the inflator 36. The inflator 36 is configured such that the gas is blown out from the gas blowing outlet 36a in a radial direction.

A flange 38 for fixing the inflator 36 is installed in a protruding manner at a side circumferential surface of the inflator 36 at a middle part of the circular cylinder in the axis direction (at a rear side from the gas blowing outlet). In the flange 38, bolt penetrating holes 40 are formed. A distal side of the inflator 36 is fit into the inflator-attaching opening 32 of the retainer 30.

When the airbag 10 is attached to the retainer 30, a peripheral edge portion of the inflator-attaching opening 16 of the rear panel 14 and that of the inflator-attaching opening 24 of the second inner panel 22B are pressed on a peripheral edge portion of the inflator-attaching opening 32 of the retainer 30 by a holding ring 42. The distal side of the inflator 36 that is fit into the inflator-attaching opening 32 is inserted into the first chamber 1 via the inflator-attaching openings 16 and 24. Thereby, each of the gas blowing outlet 36a disposed at the distal side of the inflator 36 faces each of the rear-side openings 27 of the second inner panel 22B.

In this case, the second inner panel 22B, the airbag 10, and the inflator 36 are fixed to the retainer 30 by inserting a stud bolt 44 of the holding ring 42 into the bolt penetrating holes 26, 20, 34, and 40 and by screwing a nut 46 at an end thereof. Then, the airbag apparatus is formed by folding up the airbag 10 and attaching a module cover 48 such that the body of the folded airbag 10 is covered by the module cover 48. The airbag apparatus is installed in a steering wheel 50 of an automobile (Only a rim portion is shown in FIG. 1).

In the event of a collision of a motor vehicle, or the like, the inflator 36 activates and the gas is blown out from the inflator 36 into the airbag 10. The airbag 10 is expanded by the gas and pushes open the module cover 48 deploying in a vehicle interior to protect an occupant seated in the driver's seat.

In this embodiment, as the sum Ar of the opening areas of the rear-side openings 27 and 28 is greater than the sum Af of the opening areas of the front-side openings 29, a larger amount of the gas in the first chamber 1 flows out from the rear-side openings 27 and 28 than from the front-side openings 29, and thereby an expanding speed of the airbag 10 in a radial direction increases. Further, as the sum A of the opening areas of each of the rear-side openings 27 and 28, and the front-side openings 29 is greater than the sum S of the opening areas of the vent holes 18, the amount of the gas flowing into the second chamber 2 becomes greater than that flowing out from the vent hole 18 and the entire airbag 10 including the second chamber 2 completes expanding operation earlier.

In particular, in the airbag 10 of this embodiment, the rear-side opening 27, which allows the first chamber 1 to communicate with the second chamber 2, is formed in extension of the gas blowing-out direction of the inflator 36 disposed in the first chamber 1. In other words, the rear-side opening 27 is formed at a position facing the gas blowing outlet 36a of the inflator 36, and the gas is blown out toward the rear-side opening 27 from the gas blowing outlet 36a, when the inflator activates. Accordingly, the gas blown out from the inflator 36 is directly supplied to the second chamber 2 via the rear-side opening 27 as shown in FIG. 1. The second chamber 2 is thereby able to be expanded earlier.

In the event that the occupant is displaced forward into the expanded airbag 10, the gas in an internal space of the first chamber 1 and the second chamber 2 is discharged through the rear-side opening 28 or the vent hole 18 and the impact is absorbed.

The above-described embodiment is an example of the present invention, but the present invention is not limited to the above-described embodiment. For example, in the above-described embodiment, although the gas blowing outlet 36a and the rear-side opening 27 are provided four in number, respectively, the number of the same is not limited to four. In addition, in the above-described embodiment, although the rear-side opening 27 is formed in extension of the gas blowing-out direction of the inflator 36 of all the gas blowing outlets 36a, the rear-side opening 27 may be disposed in extension of the direction of only a part of the gas blowing outlet 36a. Further, part of the rear-side opening 27 may be disposed at a position displaced from the extension of the direction of the gas blowing outlet 36a, and even a rear-side opening 27, which does not face the gas blowing outlet 36a, may represent another embodiment of the invention.

The rear-side opening 27 may have a shape other than that shown in the drawings. In addition, the opening area of the rear-side opening 27 is selected according to an inner volume of the second chamber 2, or the like, and there is no particular limitation for that.

In this example of the present invention, a guide cloth for guiding the gas to be led from the inflator 36 to the rear-side opening 27 may be provided in the first chamber 1.

In the above-described embodiment, although the rear-side openings 27 and 28 are formed in the second inner panel 22B, only one of the rear-side openings 27 or 28 may be formed in the second inner panel 22B.

In the above-described embodiment, although the first inner panel 22A is directly connected to the front panel 12 by the seam 23A, the first inner panel 22A may be connected to the front panel 12 through a connecting member such as a tether belt.

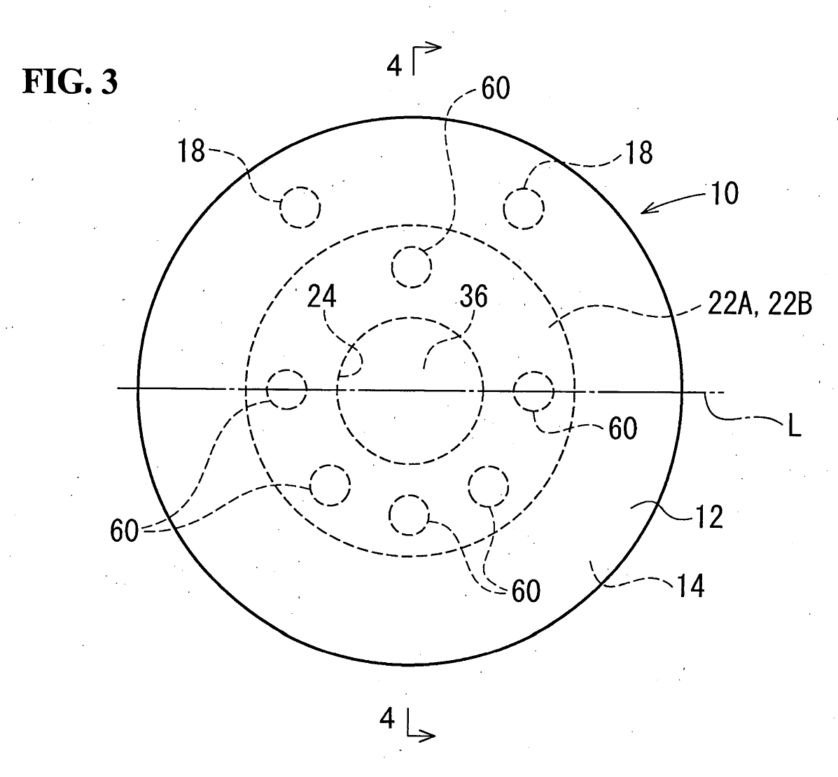

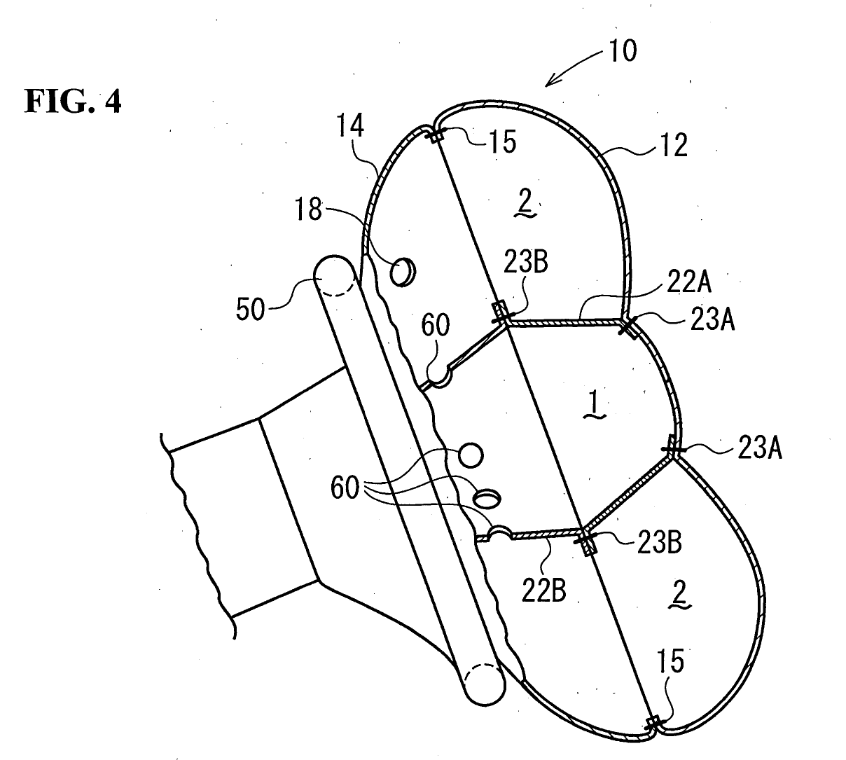

FIG. 3 is an elevation view illustrating an airbag according to a second embodiment of the invention. FIG. 4 is a cross-sectional view taken along 4-4 line of FIG. 3.

In the second embodiment, the airbag 10 is also a driver-side airbag and the airbag apparatus provided with the airbag 10 is installed in the steering wheel 50 of the automobile. As illustrated in FIG. 4, the airbag 10 expands such that the face of the occupant side of the steering wheel 50 is covered therewith.

In this embodiment, the airbag 10 is also provided with the front panel 12, the rear panel 14, the first inner panel 22A, and the second inner panel 22B, each of which is made of round-shaped woven cloth, and an outline of the airbag 10 is formed by combining each of the outer peripheral edge portions of the front panel 12 and the rear panel 14 by the seam 15. In addition, an internal part of the airbag 10 is partitioned into two of the first chamber 1 at the center of the airbag 10 and the second chamber 2 that surrounds the first chamber 1, by providing the first and second inner panels 22A and 22B at the inside thereof.

Further, a configuration and the location of the panels 12, 14, 22A and 22B, and a connected structure of the panels are the same as that in the aforementioned first embodiment, shown in FIGS. 1 and 2, and an explanation thereof will be omitted.

In the second embodiment, in the rear panel 14, the vent hole 18 is formed in an area above the center of the airbag 10 (i.e., a side above the center line L (in FIG. 3) extending in a horizontal direction through the center of the airbag. Hereinafter, a side above and below the center of the airbag 10 are referred to as a side above and below the center line L.) in a state that the airbag 10 is expanded so as to cover an occupant-side face of the steering 50.

Further, in this embodiment, two vent holes 18 are disposed in a left and right direction with a central focus on a center of the upper area of the rear panel 14 in the left and right direction spacing a predetermined distance.

In this embodiment, a plurality of openings 60 that allow the first chamber 1 to communicate with the second chamber 2 are formed in the second inner panel 22B of the rear panel 14 side. The openings 60 are disposed at an uneven distance around the inflator-attaching opening 24 (See FIG. 2, described above) located at a center of the second inner panel 22B. The openings 60 are distributed such that a sum A₂ of the opening areas of the openings 60 disposed at an area of a side below the center of the airbag 10 is greater than a sum A₁ of the opening areas of the openings 60 disposed at an area of a side above the center thereof.

In detail, as shown in FIG. 3, the openings 60 are disposed one in number at each of the positions of an upper side, a lower side, a left side, a right side, an obliquely lower side left, and an obliquely lower side right, around the inflator-attaching opening 24. In addition, the openings 60 disposed at the left side and right side of the inflator-attaching opening 24 are formed such that the openings 60 are straddling the center line L at both the upper side and the lower side from the center line L.

In this embodiment, the sum A₂ of the opening areas of the openings 60 disposed at a lower side of the airbag 10 from the center thereof is a sum of the opening areas of the three openings 60 disposed at each of the lower side, the obliquely lower side left, and the obliquely lower side right of the inflator-attaching opening 24, and the opening areas of the openings 60 disposed at each of the left side and the right side of the inflator-attaching opening 24 existing at a lower side from the center line L of the airbag 10, in the openings 60 disposed at the left side and the right side of the inflator-attaching opening 24.

Further, the sum A₁ of the opening areas of the openings 60 disposed at an upper side from the center of the airbag 10 is a sum of the opening areas of the openings 60 disposed at an upper side of the inflator-attaching opening 24, and the opening areas of the openings 60 disposed at both the left and right sides of the inflator-attaching openings 24, each of which are existing in the upper side from the center line L. That is, as for the opening 60 on the center line L, the opening area of the opening 60 existing in the upper side from the line L is considered to be joined to the sum of the upper side areas A₁ and the opening area of the opening 60 existing in the lower side from the center line L is considered to be joined to the sum of the lower side areas A₂.

Further, the two vent holes 18 are disposed to be out of the extension line in the gas blowing-out direction from the opening 60 disposed at the upper side of the inflator-attaching opening 24 and a predetermined area of a periphery of the extension line.

Other configurations of the airbag 10 and other configuration of the driver-side airbag apparatus having the airbag 10 are the same as the embodiment illustrated in FIGS. 1 and 2, and thus, the same reference number of the element in FIGS. 1 and 2 denotes the element in FIGS. 3 and 4.

In this embodiment, in the event of the collision of the motor vehicle, or the like, the inflator 36 is activated and the gas blows out into the airbag 10. The airbag 10 is thereby expanded and pushes open the module cover (not shown in FIG. 4). The airbag thereby protects the occupant in the driver's seat by being expanded and by deploying such that the airbag covers a face of an occupant-side steering wheel 50.

In this embodiment, as the vent hole 18 is disposed at the side above the center of the airbag 10 and the opening 60 that allows the first chamber 1 to communicate with the second chamber 2 is distributed such that the sum A₂ of the opening areas of the openings 60 disposed in the area of the side below the center of the airbag 10 is greater than the sum A₁ of the opening areas of the openings 60 disposed at a side above the center of the airbag 10, any potential problem such that the in-flow gas into the second chamber 2 simplistically flows toward the vent hole 18 and is discharged from the airbag 10 is suppressed. Thereby, the entire airbag 10, including the second chamber 2, completes the expanding operation earlier.

Furthermore, by thus designing the sum A₂ of the opening areas of the openings 60 disposed at the area of a side below the center of the airbag 10 to be greater, expansion of the airbag 10 at the side below the center thereof is promoted. Accordingly, the airbag 10 can suppress a forward displacement of the occupant by catching a chest region or an abdominal region of the occupant earlier.

In the present invention, when the airbag is used in the driver's seat connected to the steering wheel and is expanded in a manner so as to cover the driver side of the steering wheel, it is preferable that continuous openings for allowing the first chamber to communicate with the second chamber is provided in the inner panel at least three in number to be disposed at approximately even intervals around a center of the rotation shaft of the steering wheel.

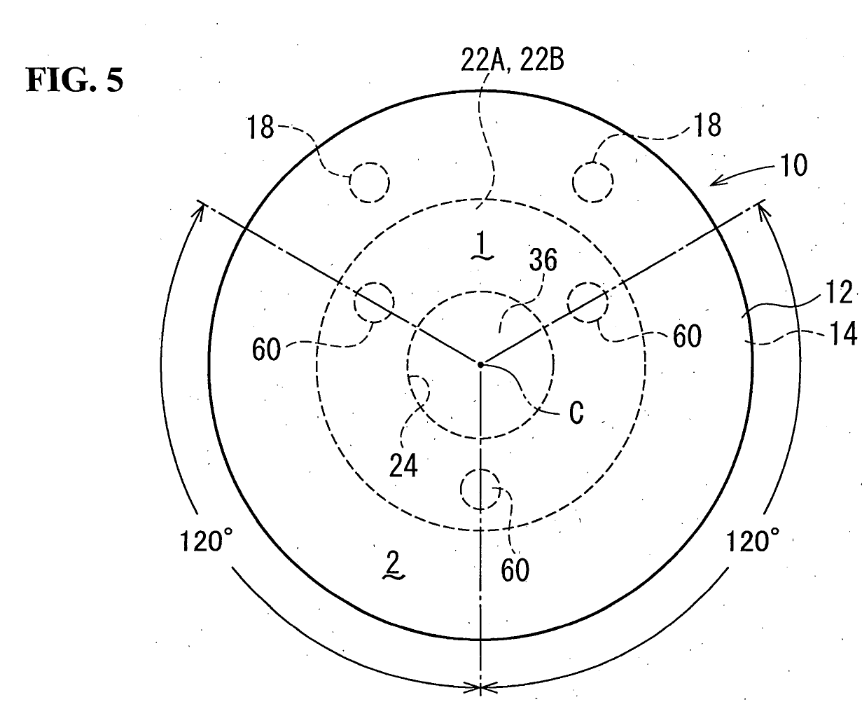

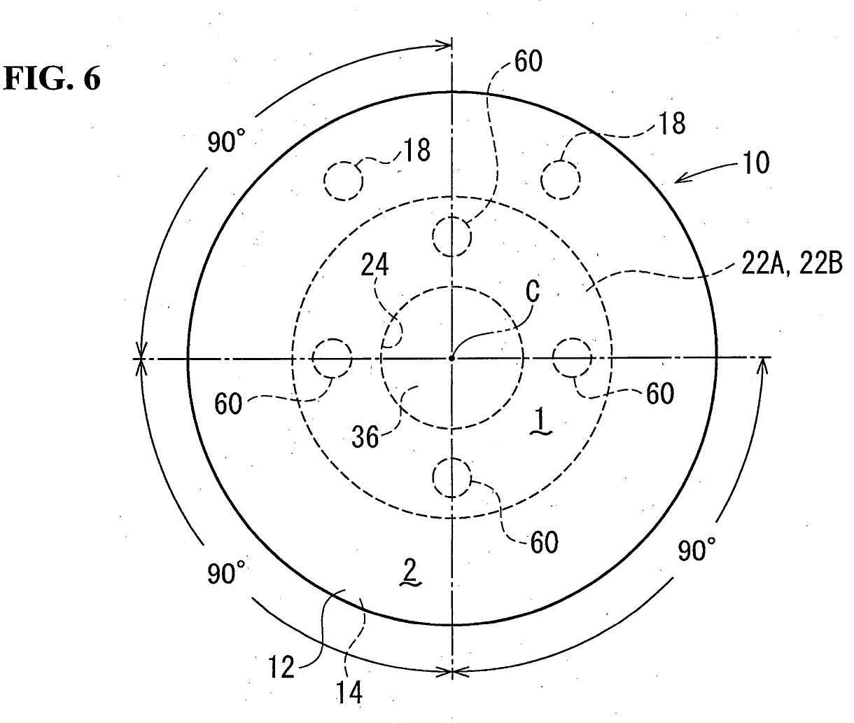

FIGS. 5 and 6 are plan views respectively illustrating examples of the thus constructed airbag for use in the driver's seat. Further, FIG. 5 illustrates an example where the openings are disposed three in number in the inner panel, and FIG. 6 illustrates another example where the openings are disposed four in number in the inner panel.

Even in each of the embodiments, shown in FIGS. 5 and 6, the airbag 10 is composed of the front panel 12, the rear panel 14, and the first and second inner panels 22A and 22B, each of which is formed of round shaped woven cloth, by means of stitching. A peripheral edge portion of the opening 24 for the inflator provided at a center of the rear panel 14 is connected to the retainer (not shown), and the airbag 10 is mounted on a center portion (hub portion) of the steering wheel (not shown) via the retainer. The airbag 10 is expanded and developed in a manner so as to cover the occupant side of the steering wheel. In each of the embodiments shown in FIGS. 5 and 6, a center (a center of the first chamber 1) of the airbag 10, when the airbag is expanded, is disposed concentrically with a center C of the rotation shaft of the steering wheel. The center of the airbag 10, when the airbag is expanded, may be deviated in some degree from the center C of the rotation shaft of the steering wheel.

In the embodiment, shown in FIG. 5, three openings 60 are disposed in approximately even intervals (approximately at every 120°) around a center C of the rotation shaft of the steering wheel in the inner panels 22A or 22B. Further, one of the three openings 60 is disposed below the center C of the rotation shaft of the steering wheel in the vertical direction when the steering wheel has a steering posture that drives a motor vehicle straight forward, and the remaining two openings are respectively disposed diagonally upward left and diagonally upward right from the center C of the rotation shaft of the steering wheel.

In the embodiment, shown in FIG. 6, four openings 60 are disposed in approximately even intervals (approximately at every 90°) around a center C of the rotation shaft of the steering wheel in the inner panels 22A or 22B. Further, the openings 60 are respectively disposed above and below the center C of the rotation shaft of the steering wheel in the vertical direction and the left and the right from the center C of the rotation shaft of the steering wheel when the steering wheel has a steering posture that drives the motor vehicle straight forward.

The construction other than that in the embodiments shown in FIGS. 5 and 6 is the same as that of the embodiments shown in FIGS. 3 and 4, described above, and the same numerals in FIGS. 5 and 6 as those in FIGS. 3 and 4 denote the same elements in FIGS. 3 and 4.

As described in the embodiments shown in FIGS. 5 and 6, when at least three openings 60 are disposed around the center C of the rotation shaft of the steering wheel in approximately even intervals in the inner panels 22A and 22B, in any angles of the steering wheel (as a steering posture), at least one opening 60 exists at a side lower than the center C of the rotation shaft of the steering wheel. Therefore, in any angle of the steering wheel, the gas is supplied from the first chamber 1 to the lower side of the second chamber 2.

Though not shown, more than five openings 60 may be disposed around the center C of the rotation shaft of the steering wheel in approximately even intervals in the inner panels 22A, or 22B.

However, when more than four openings 60 are disposed in the inner panels 22A or 22B, it is sufficient that a positional relationship among at least three openings 60 is in approximately even intervals around the center C of the rotation shaft of the steering wheel.

In addition, as also shown in FIG. 4, the steering wheel is usually tilted in a manner such that as the portion on the steering wheel is lower, the interval between the steering wheel and the occupant becomes narrower. Therefore, it is required that the lower portion side of the airbag that covers the lower portion side of the steering wheel is promptly expanded and developed in the airbag for use in the driver's seat.

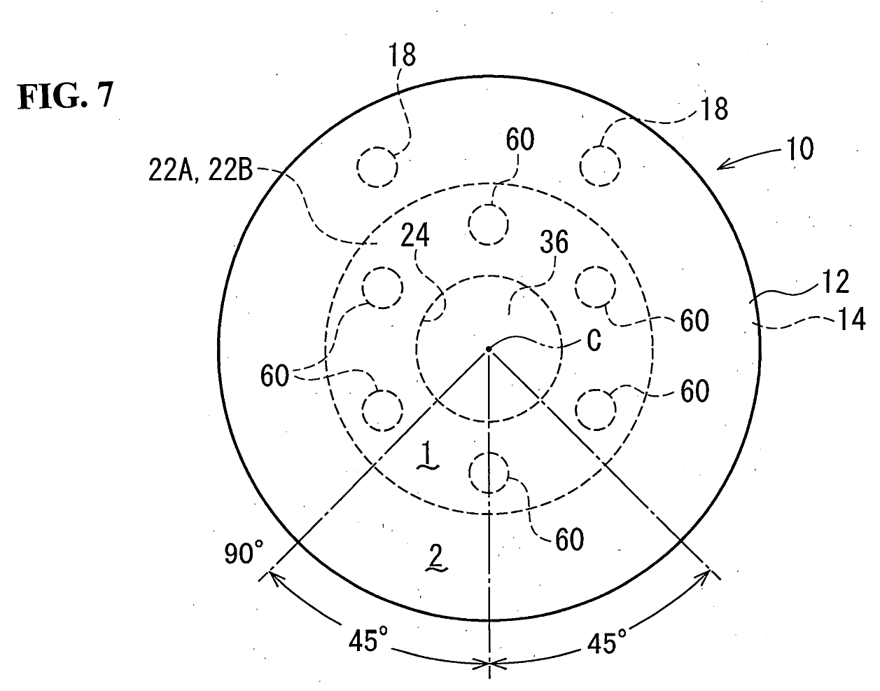

In the present invention, in a case when the airbag is used in a driver's seat, it is preferable that when the steering wheel has a posture that drives a motor vehicle straight forward, at least one continuous opening for allowing the first chamber to communicate with the second chamber is disposed in the inner panel within areas of approximately 45° in the left and right directions around a shaft of the steering wheel relative to a line extending downwardly from the shaft of the steering wheel. FIG. 7 is a plan view showing an example of the thus constructed airbag.

In this embodiment, in the inner panels 22A or 22B, six openings 60 are disposed around the center C of the rotation shaft of the steering wheel in approximately even intervals (approximately in every 60°). As shown in FIG. 7, at least one of six openings 60 is disposed in the inner panel within the areas of approximately 45° in the left and the right directions around the rotation center C of the shaft of the steering wheel relative to a line extending downwardly from the shaft of the steering wheel when the steering wheel has a posture that drives the motor vehicle straight forward.

The construction other than that in the embodiment shown in FIG. 7 is the same as that of the embodiment shown in FIGS. 3 and 4 described above, and the same numerals in FIG. 7 as those in FIGS. 3 and 4 denote the same elements in FIGS. 3 and 4.

In the airbag 10 in this embodiment, the expansion and the development at a lower side of the second chamber 2 toward the lower side of the steering wheel where the interval between the occupant and the steering wheel is narrower is accelerated.

Further, in the inner panels 22A and 22B, when the steering wheel has a posture that drives the motor vehicle straight forward, not less than two openings may be disposed in the inner panel within areas in approximately 45° in the left and the right directions around the shaft of the steering wheel relative to the line extending downwardly from the shaft of the steering wheel. The number and the position of the openings 60 disposed out of the areas are not limited to that shown in FIG. 7.

In addition, the embodiments are also examples of the present invention, and the configuration such as the shape, the number, and the disposition of the openings and the vent holes, is not limited to this embodiment.

The disclosures of Japanese Patent Application Nos. 2005-004093 filed on Jan. 11, 2005, No. 2005-164227 filed on Jun. 3, 2005, and No. 2005-359173 filed on Dec. 13, 2005 are incorporated herein.

What is claimed is:

1. An airbag capable of being expanded by gas from a gas generator, the airbag comprising:
a front panel portion disposed at an occupant side, and a rear panel portion disposed at a side opposite to the occupant;
an attaching opening for the gas generator provided in a center of the rear panel portion;
an inner panel disposed inside the airbag, partitioning an internal part of the airbag into a first chamber at a center thereof and a second chamber surrounding the first chamber; and
at least one opening, provided in the inner panel, for allowing the first chamber to communicate with the second chamber,
wherein an opening area of the at least one opening is from 40 cm² to 700 cm².

2. The airbag according to claim 1, wherein said rear panel portion includes at least one vent hole, and a sum A of an opening area of the at least one opening is greater than a sum S of an opening area of the at least one vent hole.

3. The airbag according to claim 2, wherein said at least one vent hole is disposed at a side above the center of the airbag when the airbag is in a state of being installed in a high-speed mobile unit, and
said at least one opening includes at least one upper opening above the center of the airbag and at least one lower opening below the center of the airbag, a sum A₂ of the opening area of the at least one lower opening being greater than a sum A₁ of the opening area of the at least one upper opening.

4. The airbag according to claim 1, wherein said inner panel includes a front-side opening of the front panel portion and a rear-side opening of the rear panel portion for serving as the opening, a sum Ar of an opening area of the rear-side opening being greater than a sum Af of an opening area of the front-side opening.

5. The airbag according to claim 1, wherein a thickness of the airbag is from 20 to 35 cm, when the airbag is expanded.

6. The airbag according to claim 2, wherein the sum A is from 50 cm² to 600 cm².

7. The airbag according to claim 1, wherein each of peripheral edge portions of the front panel portion and the rear panel portion is connected together.

8. The airbag according to claim 2, wherein the sum A is from 80 to 200 cm².

9. The airbag according to claim 1, wherein the airbag is an airbag for use in a driver's seat connected to a steering wheel and is expanded in a manner so as to cover a driver side of the steering wheel, and at least three openings are provided to be disposed around a center of a rotation shaft of the steering wheel in substantially even intervals in the inner panel.

10. The airbag according to claim 1, wherein the airbag is an airbag for use in a driver's seat connected to a steering wheel and is expanded in a manner so as to cover a driver side of the steering wheel, and when the steering wheel has a posture that drives a high-speed vehicle straight forward, at least one opening is disposed in the inner panel within areas in each of approximately 45° in left and the right directions around a shaft of the steering wheel relative to a line extending downwardly from the shaft of the steering wheel.

11. An airbag apparatus comprising:
an airbag according to claim 1; and
a gas generator having a gas blowing outlet.

12. The airbag apparatus according to claim 11, wherein said inner panel includes a plurality of said openings, and said gas generator includes a plurality of gas blowing outlets disposed in a circumferential direction of the generator for delivering the gas in a radial direction.

13. The airbag apparatus according to claim 12, wherein each of a portion of the plurality of openings is positioned to face each of the plurality of gas blowing outlets.

14. The airbag apparatus according to claim 13, wherein the gas blowing outlets and the openings are disposed at even distances in the circumferential direction of the generator.
